(19) United States
(12) Patent Application Publication
(10) Pub. No.: US 2006/0034522 A1
(43) Pub. Date: Feb. 16, 2006

(54) Method and system for equalizing video quality using selective re-encoding

(76) Inventor: Nader Mohsenian, Lawrence, MA (US)

Correspondence Address: MCANDREWS HELD & MALLOY, LTD, 500 WEST MADISON STREET, SUITE 3400, CHICAGO, IL, 60661, US

(21) Appl. No.: 10/915,178

(22) Filed: Aug. 10, 2004

(51) Int. Cl. G06K 9/36

(52) U.S. Cl. 382/232

(57) ABSTRACT

In a video processing system, a method and system for equalizing video quality using selective re-encoding are provided. Increasing the occurrence frequency of intra-coded pictures may improve video encoding quality by optimizing a target bit-budget for a specified group-of-pictures structure. Selected predictive and/or bidirectional-predictive pictures may be re-encoded as virtual intra-coded pictures to increase the occurrence frequency of intra-coded pictures. The virtual intra-coded pictures may not be placed in a bit stream output but may be utilized to generate statistical information to determine the frequency of occurrence of available picture coding types. The generated statistical information may be utilized to modify a target picture bits estimation model and may be also be utilized by a picture quality equalizer to configure a selective re-encoding path for re-encoding the selected pictures.

### CROSS-REFERENCE TO RELATED APPLICATIONS/INCORPORATION BY REFERENCE

This application makes reference to U.S. application Ser. No. ______ (Attorney Docket No. 16010US01), filed concurrently.

The above stated application is hereby incorporated herein by reference in its entirety.

### FIELD OF THE INVENTION

Certain embodiments of the invention relate to the processing of video signals. More specifically, certain embodiments of the invention relate to a method and system for equalizing video quality using selective re-encoding.

### BACKGROUND OF THE INVENTION

Most approaches to digital video compression partition the source video sequence into successive groups of pictures or GOPs, where each GOP picture may be of a pre-defined picture coding type. These picture coding types may comprise intra-coded pictures, predicted pictures, and bidirectional-predicted pictures. The intra-coded or “I” pictures may only use the information within the picture to perform video compression. These self-contained “I” pictures provide a base value or anchor frame that is an estimate of the value of succeeding pictures. Each GOP may generally start with a self-contained “I” picture as the reference or anchor frame from which the other pictures in the group may be generated for display. The GOP frequency, and correspondingly the frequency of “I” pictures, may be driven by specific application spaces. The predicted or “P” pictures may use a motion estimation scheme to generate picture elements that may be predicted from the most recent anchor frame or “I” picture. Compressing the difference between predicted samples and the source value results in better coding efficiency than that which may be achieved by transmitting the encoded version of the source picture information. At the receiver or decoder side, the compressed difference picture is decoded and subsequently added to a predicted picture for display.

Motion estimation may refer to a process by which an encoder estimates the amount of motion for a collection of picture samples in a picture “P”, via displacing another set of picture samples within another picture. Both sets of picture samples may have the same coordinates within their corresponding pictures and the displacing may be performed within a larger group of picture samples labeled a motion window. Motion estimation is motivated by minimizing the difference between the two sets of picture samples. A displaced set of picture samples corresponding to a minimum difference may be considered the best prediction and may be distinguished by a set of motion vectors. Once all the motion vectors are available, the whole picture may be predicted and subtracted from the samples of the “P” picture. The resulting difference signal may then be encoded.

Motion compensation may refer to a process by which a decoder recalls a set of motion vectors and displaces the corresponding set of picture samples. Output samples may be decoded or reconstructed by adding the displaced samples to a decoded difference picture. Because it may be desirable to produce a drift-free output stream, both the encoder and the decoder need access to the same decoded pictures in order to utilize the decoded pictures as basis for estimation of other pictures. For this purpose, the encoder may comprise a copy of the decoder architecture to enable the duplication of reconstructed pictures. As a result, the final motion estimation and final displacement may be done on reconstructed pictures.

Since both the “I” pictures and the “P” pictures may be used to predict pixels, they may be referred to as “reference” pictures. The bidirectional-predicted pictures or “B” pictures may use multiple pictures that occur in a future location in the video sequence and/or in a past location in the video sequence to predict the image samples. As with “P” pictures, motion estimation may be used for pixel prediction in “B” pictures and the difference between the original source and the predicted picture may be compressed. At the receiver or decoder end, one or more pictures may be motion compensated and may be added to the decoded version of the compressed difference signal for display.

Because “I” pictures rely on intra-coding schemes, they may require more bits than other picture coding types. The “B” pictures may depend on multiple predictions and may not generally be used to predict samples in other pictures, therefore “B” pictures may require fewer number of bits than “I” pictures. The number of bits necessary for “P” picture coding may be somewhere between the number of bits necessary for “I” pictures and “B” pictures. The bit-budget or bit-rate for a specified GOP may vary and may depend on the system requirements and/or its operation. The ratio of bit-budgets or bit-rates between “I”, “P”, and “B” picture coding types in a specified GOP may be chosen such that the coding may result in similar video quality, or similar distortion artifacts, for the various picture types.

However, in practice the task of achieving consistent video quality among pictures types may be a very difficult one. A digital video encoder, for example, may be required to assign the number of bits for each picture type subject to conditions set by the bandwidth of the transmission channel and/or by the size of a storage device, all while maintaining optimum video quality. A rate-distortion profile may be typically used to predict the number of picture bits and a picture quantizer for a picture coding type. This means that for a bit-stream composed of N picture types, the video encoder would have to adopt N rate-distortion models, each dedicated to a picture coding type, to achieve its goal. Since video is non-stationary by nature, each rate-distortion model has to be adapted in real-time to correspond to the content of the video source. This adaptation model may also have to be optimized so that it may be implemented in an integrated circuit (IC). Rate control is the task of estimating rate-distortion parameters and ensuring that the bit-stream meets its target bit rate.

Some rate control methods may perform a quick preview of the video source by calculating some form of spatial or temporal statistical measure, which may be used to update the rate-distortion profile parameters. More complex schemes may offer a two-encoder solution, for example, one encoder may be followed by a delayed second encoder, to compute the actual number of picture bits and the quantizer. The two-encoder solution may produce a better result but it may also require considerable more area in a silicon IC, especially when high definition TV (HDTV) material is to be compressed.

For non-real time compression solutions, the encoder may afford to compress the source video a number of times in order to achieve the desired video quality. In this scenario, actual bits, quantizer, and other measurements may be used to update rate-distortion parameters prior to the next round of encoding, allowing for an optimal video quality to be attained.

While the compression approaches described above are driven by different applications and may vary in terms of hardware and software complexity, they each share the requirement that the right number of “I”, “P” and “B” picture types be encoded and inserted in the appropriate time intervals to economize the available bit-budget in a specified GOP. Demands for cutting edge encoding technology is driven by the fact, that even under the most difficult scenarios, good quality streams at low bit rates may be required in video applications. This means that “I” picture types, which generally consume the most number of bits, may need to be avoided when possible. On the other hand, certain applications, for example, broadcast video, editing, DVD playback, and/or trick modes, may require random accessing of the compressed bit-stream, which necessitates the use of “I” pictures as the reference or anchor frame for the access entry point. In broadcast video, for example, when channel switching occurs, there may be a disruption in the video quality until the next “I” picture appears. In the absence of “I” pictures, output video may not be able to re-synchronize itself and may drift away. In storage applications, for example, when trick modes or still playbacks are used, the “I” pictures present useful access points for fast forward preview of the stream. There are other scenarios as in temporal discontinuities, for example in scene cuts and severe fades, where insertion of an “I” picture may be quite useful.

To satisfy requirements for both encoding application spaces and compression efficiency, encoders choose to insert an “I” picture type at pre-defined temporal locations where the location of an “I” picture generally corresponds with the start of a GOP. For example, such points may occur in ½ second or 1 second time intervals, depending on the system and the application. The more economical “P” and “B” picture types may occur more frequently than the self-contained “I” picture. More frequent use of “I” pictures may severely degrade the video quality of output streams and may be recommended when high-bit rates may be possible in a specified application. Once the frequency of “I”, “P”, and “B” pictures is determined within the time window of a GOP, the encoder may then allocate picture bits among various picture types subject to the GOP bit-budget or bit-rate. The amount of bits that may be allocated for each picture type may depend on the remaining number of bits in the bit-budget, some forms of “look-ahead” spatial or temporal statistics, and the coding parameters from previous pictures. The use of the bit-budget, statistics, and coding parameters is the basis of rate control learning, which may be used to mimic the contents of picture types and to predict new coding parameters for future pictures.

Because different picture types may use different amount of bits, their rate distortion profiles may be updated independently. However, different picture types may still have to compete for bits given the target bit-budget in the specified GOP. One important factor in the rate control learning scheme is the frequency of a picture type within the video stream. Picture types “P” and “B” appear frequently in the source and changes in their spatial and temporal characteristics can be profiled or “learned” at an acceptable rate. On the other hand, “I” pictures tend to be much further apart and their compression efficiency suffers from a slower learning process.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention may be found in a method and system for equalizing video quality using selective re-encoding. Aspects of the method may comprise selecting at least one picture in a video sequence for re-encoding. Re-encoding may take place before the selected pictures are encoded or may take place after the selected pictures are encoded. Statistical information may be generated from the re-encoded pictures and may be utilized to modify a target picture bits estimation model. A portion of a GOP target bit-budget may be assigned based on the generated statistical information. The generated statistical information may also be utilized to determine which pictures in the video sequence to select for re-encoding.

The selected pictures from the video sequence may be from at least one specified picture coding type. The specified picture coding type may be predicted pictures, bidirectional predictive pictures, or predictive and bidirectional-predictive pictures. The selected pictures may be re-encoded into a specified virtual picture coding type, where intra-coded pictures may be selected as the specified virtual picture coding type. Before re-encoding, the selected pictures may be scaled and/or sub-sampled.

Aspects of the system may comprise a picture quality equalizer that selects at least one picture in a video sequence for re-encoding by at least one picture type encoding engine. Re-encoding by the picture type encoding engine may take place before the selected pictures are encoded or may take place after the selected pictures are encoded. The picture quality equalizer may generate statistical information from the re-encoded pictures and may utilize the generated statistical information to modify a target picture bits estimation model in a bit estimator. A portion of a GOP target bit-budget may be assigned by the bit estimator based on the generated statistical information. The generated statistical information may also be utilized by the picture quality equalizer to determine which pictures in the video sequence to select for re-encoding.

The picture quality equalizer may select pictures from the video sequence from at least one specified picture coding type. The specified picture coding type may be predicted pictures, bidirectional predictive pictures, or predictive and bidirectional-predictive pictures. The selected pictures may be re-encoded by the picture type encoding engine into a specified virtual picture coding type, where intra-coded pictures may be selected as the specified virtual picture coding type. Before re-encoding, a pre-processor may scale and/or sub-sample the selected pictures. A parametric video quality equalizer may determine the pictures in the video sequence to select for re-encoding and may configure a selective re-encoding path to re-encode the selected pictures.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram of an exemplary GOP structure comprising picture coding types “I”, “P”, and “B”, in connection with an embodiment of the invention.

FIG. 1B is a diagram of an exemplary GOP with virtual “I” pictures at selected “P” picture locations, in accordance with an embodiment of the invention.

FIG. 1C is a diagram of an exemplary GOP with virtual “I” pictures at selected “P” and “B” picture locations, in accordance with an embodiment of the invention.

FIG. 2 is a block diagram of an exemplary encoder architecture with picture quality equalizer, in accordance with an embodiment of the invention.

FIG. 3 is a block diagram of an exemplary picture quality equalizer, in accordance with an embodiment of the invention.

FIG. 4 is a diagram that illustrates an exemplary parametric video quality equalizer based on a compression variation parameter, α, in accordance with an embodiment of the invention.

FIG. 5A is a table that illustrates bits storage indexing based on picture coding type and band, in accordance with an embodiment of the invention.

FIG. 5B is a table that illustrates temporary bits storage indexing for picture coding type m, in accordance with an embodiment of the invention.

FIG. 6A is a table that illustrates quantizer storage indexing based on picture coding type and band, in accordance with an embodiment of the invention.

FIG. 6B is a table that illustrates temporary quantizer storage indexing for picture coding type m, in accordance with an embodiment of the invention.

FIG. 7A is a table that illustrates distortion storage indexing based on picture coding type and band, in accordance with an embodiment of the invention.

FIG. 7B is a table that illustrates temporary distortion storage indexing for picture coding type m, in accordance with an embodiment of the invention.

FIGS. 8A-8D illustrates exemplary band configurations, in accordance with an embodiment of the invention.

### DETAILED DESCRIPTION OF THE INVENTION

Certain embodiments of the invention may be found in a method and system for equalizing video quality using selective re-encoding. The encoding frequency of picture coding type “I” may be increased by compressing selected pictures in a video sequence first either as a picture coding type “P” or “B”, as required by the structure of the group-of-pictures (GOP), and later re-encoding the picture as a pictured coding type “I”. By re-encoding selected source pictures as “I” pictures, the speed at which a target picture bits estimation model in a video encoder adapts to source information may be greatly accelerated, enhancing the performance of the video encoder by reducing artifacts that may result from reduced temporal coherence between “I” pictures.

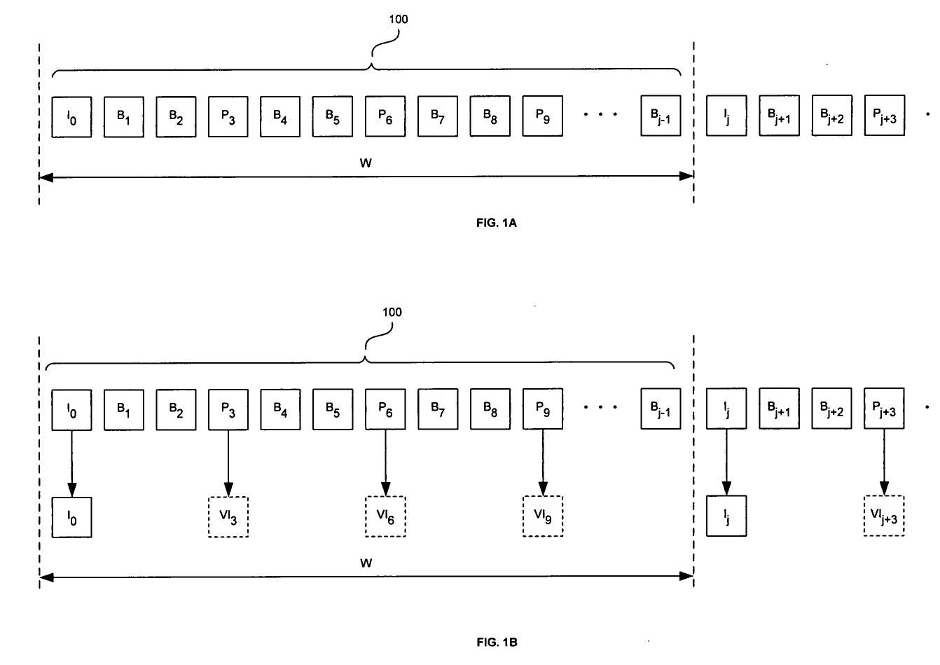

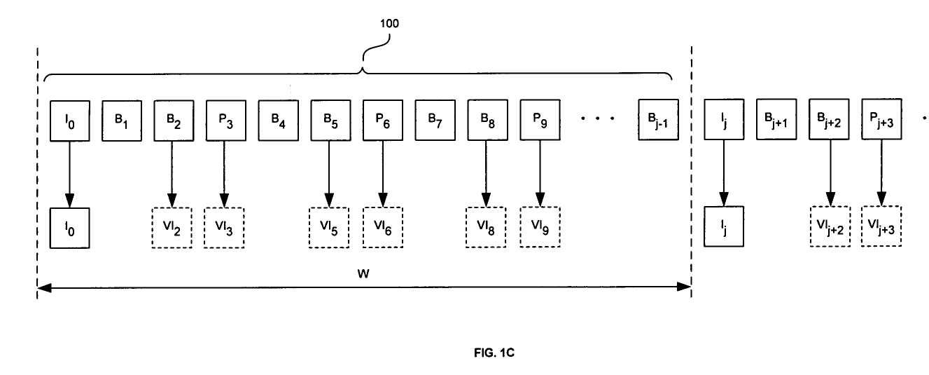

FIG. 1A is a diagram of an exemplary GOP structure comprising picture coding types “I”, “P”, and “B”, in connection with an embodiment of the invention. Referring to FIG. 1A, the GOP structure 100 may comprise a plurality of picture coding types “I”, “P”, and “B” with a size determined by the parameter W, where W=j. In this exemplary structure, any two neighboring non-B pictures are separated by two “B” pictures. The GOP structure 100 may be utilized for video compression in, for example, broadcasting applications, web casting, and/or video playback. The labels “I”, “P”, and “B” utilized in FIG. 1A to identify the pictures in the video sequence correspond to the picture coding types “I”, “P”, and “B” respectively. The numerical indexing utilized with the labels in FIG. 1A corresponds to the picture location in the video sequence. For example, picture P₃ is the fourth picture in the sequence and it is a “P” picture, while picture Bⱼ₊₂ is the (j+3)^{th} picture in the sequence and it is a “B” picture.

The rate control methodology utilized in the encoder may be responsible for distributing the bits available in a GOP bit-budget among the various picture types based on a pre-defined weighting scheme which may favor “I”, then “P”, and lastly “B” pictures. For example, for a given picture coding type, a model may be utilized for estimating the number of target picture bits based on previously computed picture bits having the same picture coding type and also on any bits that may remain available in the GOP bit-budget. Additional compression parameters such as, for example, a picture quantizer scale factor from a previous picture of the same coding type, may also be utilized in the target picture bits estimation model. Because different picture types consume or utilize different numbers of picture bits, independent bit estimation profiles may be adopted to compute target picture bits for each of the picture coding types.

In the exemplary video sequence shown in FIG. 1A, any two consecutive “I” pictures are further apart than any two consecutive “P” pictures or any two consecutive “B” pictures. For example, pictures I₀ and Iⱼ are consecutive “I” pictures separated by the GOP size parameter W, where I₀ is the first picture in the video sequence and in the GOP structure 100. Pictures B₂ and B₄ in GOP structure 100 are consecutive “B” pictures separated by picture P₃, while pictures P₃ and P₆ in GOP structure 100 are consecutive “P” pictures separated by pictures B₄ and B₅. The “I” pictures appear less frequently than “P” or “B” pictures in order to improve the overall quality of the video bit-stream. As a result, a weaker temporal correlation may exist between consecutive “I” pictures in the video sequence and, consequently, the target picture bits estimation model for “I” pictures may be less efficient than for “P” or “B” pictures.

FIG. 1B is a diagram of an exemplary GOP with virtual “I” pictures at selected “P” picture locations, in accordance with an embodiment of the invention. Referring to FIG. 1B, the pictures in the GOP structure 100 may be used to generate a plurality of virtual “I” pictures or “VI” pictures at selected “P” picture locations. This approach may increase the temporal correlation of “I” pictures by encoding at least one picture in the video sequence as a “VI” picture. For example, “P” pictures P₃, P₆, P₉, . . . , Pⱼ₊₃, . . . , in the video sequence may also be encoded as “VI” pictures VI₃, VI₆, VI₉, . . . , VIⱼ₊₃, . . . . Not all “P” pictures in the video sequence may be encoded, the selection and number of “P” pictures to be encoded as “VI” pictures may be determined before and/or during the encoding operation. For each GOP structure in the video sequence it may be possible to provide a different selection of “P” pictures to be encoded as “VI” pictures. The “VI” encoding process may be performed before or after the “P” encoding process takes place. The availability of an “I” and “VI” picture sequence comprising of I₀, VI₂, VI₆, . . . , Iⱼ, VIⱼ₊₃, . . . , may greatly enhance the compression efficiencies of the original sequence shown in FIG. 1A by increasing the pace of the learning. This improvement in compression efficiencies may result from utilizing compression statistics of the “I” and “VI” picture sequence to modify and/or provide additional information to target picture bits estimation model of “I” pictures for the original sequence shown in FIG. 1A. The “VI” picture in the video sequence may not appear in the output compressed bit-stream.

FIG. 1C is a diagram of an exemplary GOP with virtual “I” pictures at selected “P” and “B” picture locations, in accordance with an embodiment of the invention. Referring to FIG. 1C, virtual “I” pictures or “VI” pictures may also be encoded from selected “P” and/or “B” pictures. For example, the sequence of “B” and “P” pictures B₂, P₃, B₅, . . . , Bⱼ₊₂, Pⱼ₊₃, . . . , in the video sequence may be encoded as “VI” pictures VI₂, VI₃, VI₅, . . . , VIⱼ₊₂, VIⱼ₊₃, . . . . The selection and number of “P” and/or “B” pictures to be encoded as “VI” pictures may be determined before and/or during the encoding operation. For each GOP structure in the video sequence it may be possible to provide a different selection of “P” and/or “B” pictures to be encoded as “VI” pictures. The “VI” encoding process may be performed before or after the “P” and/or “B” encoding process takes place. A similar result may be achieved when only selected “B” pictures are encoded as “VI” pictures.

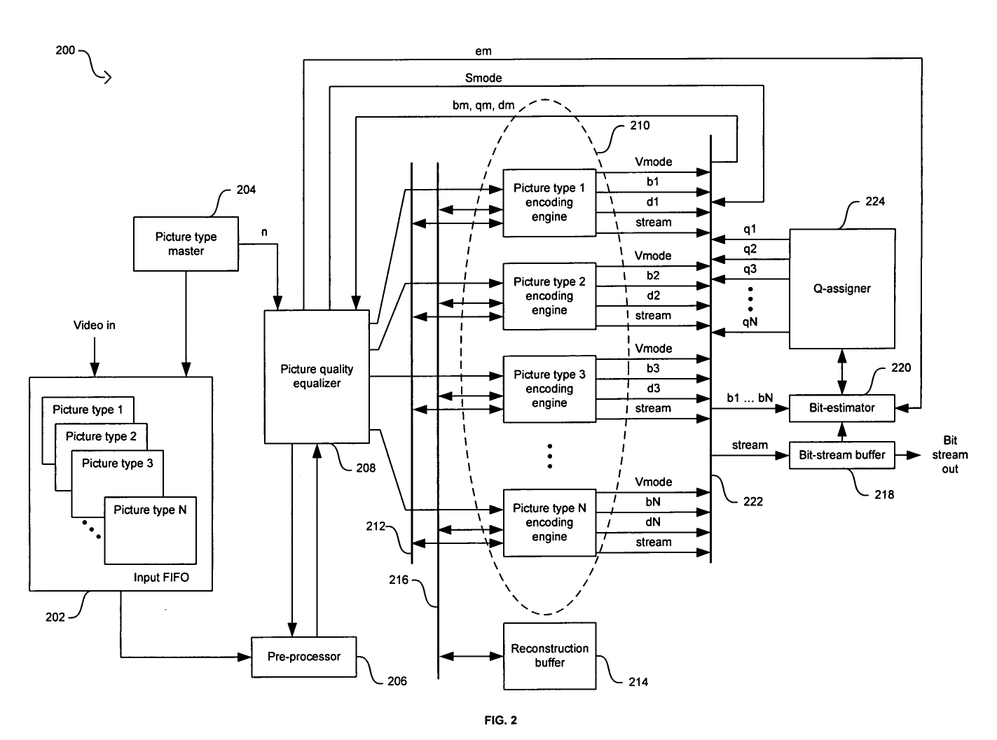

FIG. 2 is a block diagram of an exemplary encoder architecture with picture quality equalizer, in accordance with an embodiment of the invention. Referring to FIG. 2, the encoder architecture 200 may comprise an input FIFO 202, a picture type master 204, a pre-processor 206, a picture quality equalizer 208, a plurality of picture type encoding engines 210, an internal compression engine bus 212, a reconstruction buffer 214, a memory bus 216, a bit-stream buffer 218, a bit-estimator 220, an I/O stream bus 222, and a Q-assigner 224. The input FIFO 202 may comprise suitable logic, circuitry, and/or code that may be adapted for storing a plurality of pictures for encoding. The storage size of the input FIFO 202 may depend on the encoding order of the pictures in the GOP structure. The picture type master 204 may comprise suitable logic, circuitry, and/or code that may be adapted to determine the coding type, labeled n, for each of the received input pictures according to the current GOP structure. The picture type master 204 may provide the picture quality equalizer 208 with a signal indicating the picture coding type n of the picture to be encoded. There may be a plurality of picture coding types, for example, type 1 may refer to “I” pictures, type 2 may refer to “P” pictures, type 3 may refer to “B” pictures, while the remaining types in the picture type master 204 may refer to other picture coding types. In the exemplary embodiment of the encoder architecture 200 shown in FIG. 1A, there are N picture coding types that may be available for video compression or encoding. When a picture in the input FIFO 202 has been encoded, a new input picture of the same coding type may be stored in the location occupied by the encoded picture.

The pre-processor 206 may comprise suitable logic, circuitry, and/or code that may be adapted to provide image processing operations, for example, image scaling and/or image sub-sampling, before transferring the video pictures to the picture quality equalizer 208. The picture quality equalizer 208 may comprise suitable logic, circuitry, and/or code that may be adapted to provide virtual encoding by utilizing selective re-encoding. The picture quality equalizer 208 may generate an Smode signal and an em signal and may receive parameters bm, qm, and dm. The em signal may be enabled when parametric video quality equalization is performed utilizing an information parameter β instead of a compression variation parameter α. The reconstruction buffer 214 may comprise suitable logic, circuitry, and/or code that may be adapted to store reconstructed pictures that may be used by the picture type encoding engines 210 to perform temporal predictions in order to reduce picture drifting. The reconstructed pictures stored in the reconstructed buffer 214 may be shared among the picture type encoding engines 210 via the memory bus 216.

The picture type encoding engine 210 may comprise suitable logic, circuitry, and/or code that may be adapted to encode a source picture utilizing a specified picture coding type. There may be, for example, N picture type encoding engines 210 in the encoder architecture 200 shown in FIG. 1A, one for each picture coding type available in the picture type master 204. The picture type encoding engine 210 may provide at least one video signal processing operation. The video signal processing operations may comprise, but are not be limited to, block partitioning, prediction, pixel smoothing, transformation, quantization, entropy coding, entropy decoding, inverse transformation, inverse quantization, motion estimation, and/or motion compensation.

The signal processing operations may produce data which may be shared among the picture type encoding engines 200 via the internal compression bias bus 212. For example, all picture coding types may undergo a transformation operation. When the transformation operation is implemented in, for example, a picture type 1 coding engine, the remaining picture type encoding engines 210 in the encoder architecture 200 may access the transformation operation in the picture type 1 coding engine through the internal compression bias bus 212.

The picture type encoding engines 210 may generate compressed pictures and picture statistics. The compressed pictures may be embedded in an output stream and may be stored in the bit-stream buffer 218 before transmission. The picture statistics generated by the picture type encoding engines 210 may comprise bit and distortion statistics. For an N number of picture type encoding engines 210 in the encoder architecture 200, the bit statistics may be labeled bn and the distortion statistics may be labeled dn, where n corresponds to the n^{th} picture coding type. The bit statistics b1 . . . bN may be transferred to the bit-estimator 220 and/or to the picture quality equalizer 208 via the I/O stream bus 222. The distortion statistics d1 . . . dN may be transferred to the picture quality equalizer 208 via the I/O stream bus 222.

The bit-estimator 220 may comprise suitable logic, circuitry, and/or code that may be adapted execute the target picture bits estimation model. The bits estimation model may estimate the picture target bit rate (Tn) for a picture coding type based on the following expression:

$$Tn = ( en \times Rg ) / {\sum }_{n}^{} ( fn \times en ) ,$$

where n=1, 2, 3 . . . N correspond to the picture coding type under consideration, en is a measure that may correspond to the encoding difficulty in the n^{th} picture coding type, Rg is the number of GOP bits that may be derived from a selected compressed video bit-rate, and fn is the frequency of compression occurrence in the n^{th} picture coding type. To ensure that Tn for the video sequence is achieved, the difference (Δ1) between the actual bits per picture and the picture target bits may be determined periodically and may be utilized to determine the picture target bit rate as follows:

$$Tn = ( en \times ( Rg - Δ 1 ) ) / {\sum }_{n}^{} ( fn \times en ) .$$

The Q-assigner 224 may comprise suitable logic, circuitry, and/or code that may be adapted for determining a picture quantizer scale (qn) for a picture coding type. An initial picture quantizer scale (qn*) may be determined by qn*=en/Tn. The value of qn* may be modified to achieve the picture target bit rate for each picture. A difference (Δ2) between the partial target bits and the partial actual bits in the picture may be determined to modify the value of qn. Partial bit measurements correspond to blocks of, for example, 16×16 image samples. The picture quantizer scale for a block in a picture may be determined by qn=qn*−Δ2. The expression for determining the picture quantizer scale is based on the assumption that when undershooting occurs, Δ2 is a positive value and qn is reduced to increase the number of bits within the picture. When overshooting occurs, Δ2 is a negative value and qn is increased to reduce the number of bits within the picture. For an N number of picture type encoding engines 210 in the encoder architecture 200, Q-assigner 224 may generate N picture quantizer scales labeled q1 . . . qN and may transfer the picture quantizer scales to the picture quality equalizer 208 via the I/O stream bus 222. Generally, the values bn, qn, and dn for a picture coding type are determined per block of pixels, however in some instances, scalar values or other numbers may also be utilized to provide a form of averaging when appropriate.

FIG. 3 is a block diagram of an exemplary picture quality equalizer, in accordance with an embodiment of the invention. Referring to FIG. 3, the picture quality equalizer 208 may comprise a parametric video quality equalizer 302, a picture reset 304, a virtual encoder mode selector 306, a path selector 308, and an encoder selector 310. The encoder selector 310 may comprise suitable logic, circuitry, and/or code that may be adapted to select the picture type encoding engine 210 to which the output of the picture quality equalizer 208 may be transferred. For example, the selector 310 in the picture quality equalizer 208 may have N possible outputs that correspond to N possible picture type encoding engines 210 in the encoder architecture 200. The path selector 308 may comprise suitable logic, circuitry, and/or code that may be adapted to select between a basic encoding path, which may be generally adopted by real-time encoding applications, and a selective re-encoding path, where pictures from the pre-processor 206 and data from the parametric video quality equalizer 302 may be used to selectively re-encode certain picture coding types into, for example, “VI” pictures.

The parametric video quality equalizer 302 may comprise suitable logic, circuitry, and/or code that may be adapted to decide between utilizing the selective re-encoding path or the basic encoding path for picture encoding. The parametric video quality equalizer 302 may generate a signal to the pre-processor 206, the picture reset 304, and/or the virtual encode mode selector to indicate that the selective re-encoding path has been selected. The picture reset 304 may comprise suitable logic, circuitry, and/or code that may be adapted to reset a coding type from a value n to a value m, where m may correspond to the “VI” pictures coding type. The virtual encode mode selector 306 may comprise suitable logic, circuitry, and/or code that may be adapted to generate a Vmode signal to notify the path selector 308 that the selective re-encoding path has been selected. For example, a value of logic 1 for the Vmode signal may correspond to virtual encoding through selective re-encoding while a value of logic 0 may correspond to basic encoding without selective re-encoding.

In operation, the parametric video quality equalizer 302 may receive a signal from the picture type master 204 indicating the picture coding type of an input picture in the input FIFO 202. The parametric video quality equalizer 302 may determine whether selective re-encoding is to be performed on the picture to be encoded and may indicate to the pre-processor 206, the picture reset 304, and/or the virtual encode mode selector 306 when selective re-encoding is to take place. The determination of whether selective re-encoding is to be performed may depend on the values of the bit statistics, distortion statistics, and picture quantizer scales received from the I/O stream bus 222. The pre-processor 206 may perform, for example, picture scaling and/or picture sub-sampling such that the virtual encoding is done in a sub-picture domain. The picture reset 304 may reset picture coding information to indicate that, for example, the picture is to be encoded into a “VI” picture. While selective re-encoding provides an approach to enhance “I” picture statistics, the picture reset 304 may be used to reset picture coding information to any type of picture coding type supported by the encoder architecture 200.

When the selective re-encoding path is chosen, the virtual encode mode selector 306 may set the Vmode signal to logic 1 and may transfer the value of Vmode to the path selector 308 to select the appropriate input setting. The encoder selector 310 may then select the output to the appropriate picture type encoding engine 210 based on the m picture coding type that was reset in the picture reset 304. When the basic encoding path is chosen, the virtual encode mode selector 306 may set the Vmode signal to logic 0 and may transfer the value of Vmode to the path selector 308 to select the appropriate input setting. The encoder selector 310 may then select the output to the appropriate picture type encoding engine 210 based on the original picture coding type n. Information from the selectively re-encoded “VI” pictures may be utilized by the bit-estimator 220 to generate “I” picture statistics but may not be sent to the bit-stream buffer 218 to be sent to the output stream. The parametric video quality equalizer 302 may notify whether the bit-stream buffer 218 is to store the encoded picture by an Smode signal and may send parameter en to the bit-estimator 220 to provide a measure of the encoding difficulty in the n^{th} picture coding type.

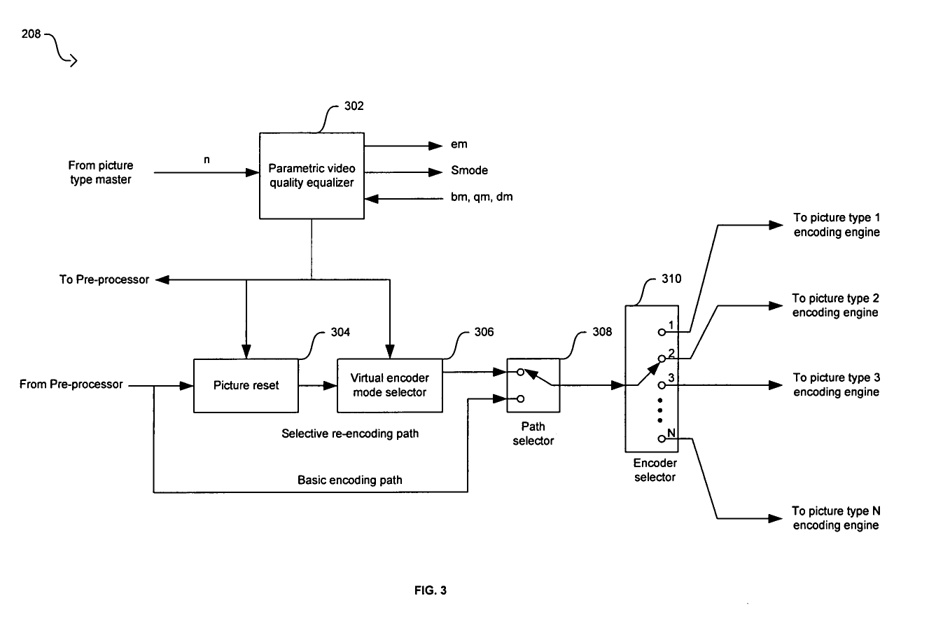

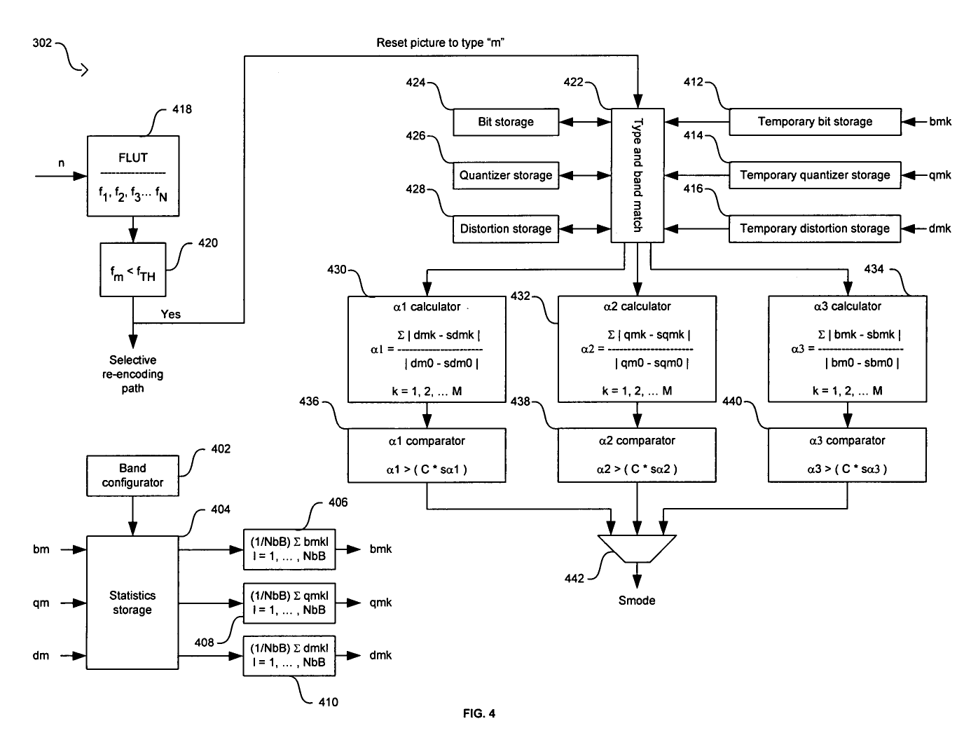

FIG. 4 is a diagram that illustrates an exemplary parametric video quality equalizer based on a compression variation parameter, α, in accordance with an embodiment of the invention. Referring to FIG. 4, the parametric video quality equalizer 302 may comprise a band configurator 402, a statistics storage 404, a bmk calculator 406, a qmk calculator 408, a dmk calculator 410, a temporary bit storage 412, a temporary quantizer storage 414, a temporary distortion storage 416, a type and band match 422, a bit storage 424, a quantizer storage 426, a distortion storage 428, a frequency look-up table (FLUT) 418, a threshold comparator 420, an α1 calculator 430, an α2 calculator 432, an α3 calculator 434, an α1 comparator 436, an α2 comparator 438, an α3 comparator 440, and a store mode decision multiplexer 442.

The band configurator 402 may comprise suitable logic, circuitry, and/or code that may be adapted to provide the statistics storage 404 with a selected band configuration for the storage of picture coding type m parameters. The statistics storage 404 may comprise suitable logic, circuitry, and/or code that may be adapted to store or buffer the parameters bits (bm), quantizer picture scale (qm), and distortion (dm) for the picture coding type m in compliance with the selected band configuration. The parameters bm, dm, and qm may be determined per block of pixels. The input of parameters bm, dm, and qm to the statistics storage 404 may be enabled when the Vmode signal from the virtual encode mode selector 306 is set to logic 1. The bmk calculator 406, the qmk calculator 408, and the dmk calculator 410 may comprise suitable logic, circuitry, and/or code that may be adapted to determine band-based averaged parameters bmk, qmk, and dmk from parameters bm, qm, and dm respectively, where parameter NbB shown in FIG. 4 corresponds to the number of blocks of pixels in the specified band and the index k corresponds to the band number. The bmk calculator 406, the qmk calculator 408, and the dmk calculator 410 may be utilized to reduce the effects of signal noise, erroneous picture bytes, and/or erroneous quantizer scale.

The FLUT 418 may comprise suitable logic, circuitry, and/or code that may be adapted to store a set of frequency of compression occurrences f₁, f₂, f₃, . . . , fN, where N corresponds to the number of picture coding types. The frequency of compression occurrence may be defined as the number of times that a picture coding type is compressed within a window in the video sequence. The window may be, for example, the size W of the GOP. The threshold comparator 420 may comprise suitable logic, circuitry, and/or code that may be adapted to compare the frequency of compression occurrence fₘ for picture coding types m, where m is any picture coding type other than n, to a threshold frequency f_{TH}. The nominal value of the threshold frequency f_{TH} may be set to a value of, for example, 4. The threshold frequency f_{TH} may be programmed before the start of operation of the encoder architecture 200 and may also be programmed during operation of the encoder architecture 200.

The temporary bit storage 412, the temporary quantizer storage 414, and the temporary distortion storage 416 may comprise suitable logic, circuitry, and/or code that may be adapted to store parameters bmk, qmk, and dmk respectively for type and band matching. The bit storage 424, quantizer storage 426, and distortion storage 428 may comprise suitable logic, circuitry, and/or code that may be adapted to store parameters sbnk, sqnk, and sdnk for type and band matching. Parameter sbnk represents stored bits for picture coding type n and band k, and corresponds to an earlier value of parameter bmk. Similarly, sqnk and sdnk represent stored quantizer scale and stored distortion for picture coding type n and band k respectively. Parameters sqnk and sdnk correspond to earlier values of parameters qmk and dmk respectively. The type and band match 422 may comprise suitable logic, circuitry, and/or code that may be adapted to match the type and band of parameters sbnk, sqnk, and sdnk to parameters bmk, qmk, and dmk respectively. The type and band match 422 may transfer corresponding values of parameters sbnk and bmk, parameters sqnk and qmk, and parameters sdnk and dmk to the α1 calculator 430, the α2 calculator 432, and the α3 calculator 434 respectively.

The α1 calculator 430, the α2 calculator 432, and the α3 calculator 434 may comprise suitable logic, circuitry, and/or code that may be adapted to determine compression variation parameters α1, α2, and α3 respectively. The parameters α1, α2, and α3 may be determined from a normalized sum of differences as shown in FIG. 4. The α1 comparator 436, the α2 comparator 438, and the α3 comparator 440 may comprise suitable logic, circuitry, and/or code that may be adapted to compare parameters α1, α2, and α3 to corresponding threshold values to determine when sufficient compression variation has occurred. The α1 comparator 436, the α2 comparator 438, and the α3 comparator 440 may each indicate to the store mode decision multiplexer 442 whether their respective compression variation parameters are larger than their corresponding threshold values. The threshold values may be determined from a constant C and parameters sα1, sα2, and sα3, where C may have a value of, for example, 2.0, and parameters sα1, sα2, and sα3 correspond to previously determined values for α1, α2, and α3 respectively. The store mode decision multiplexer 442 may comprise suitable logic, circuitry, and/or code that may be adapted to determine the value of the Smode signal based on the outputs from the α1 comparator 436, the α2 comparator 438, and the α3 comparator 440. An Smode value of logic 1 may indicate that the virtual picture is to represent a physical picture and may be stored in the outgoing compressed bit stream. An Smode signal value of logic 0 may indicate that the virtual picture is not to be stored in the outgoing compressed bit stream.

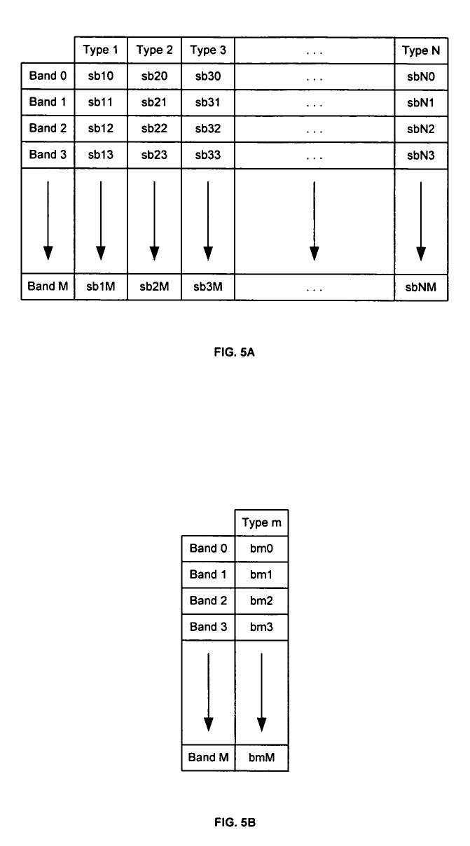

FIG. 5A is a table that illustrates bits storage indexing based on picture coding type and band, in accordance with an embodiment of the invention. Referring to FIG. 5A, the picture bits parameter sbmk may be stored in the bit storage 424 according to the table shown. The table is indexed by M rows that correspond to the band partitions and by N columns that correspond to the picture coding types. For example, for band partition 3 and picture coding type 2, the storage location in the bit storage 424 may be addressed by sb23.

FIG. 5B is a table that illustrates temporary bits storage indexing for picture coding type m, in accordance with an embodiment of the invention. Referring to FIG. 5B, the picture bits parameter bmk for picture coding type m may be stored in the temporary bit storage 412 according to the table shown. The table is indexed by M rows that correspond to the band partitions. For example, for band partition 2, the storage location in the temporary bit storage 412 may be addressed by index bm2.

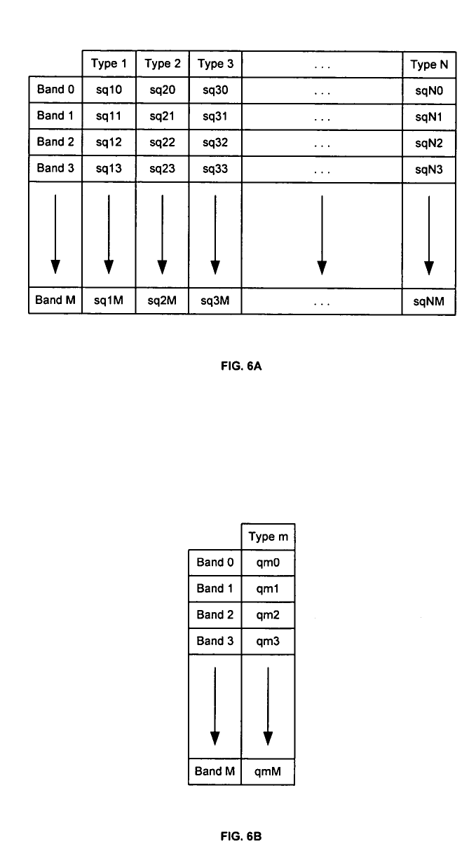

FIG. 6A is a table that illustrates quantizer storage indexing based on picture coding type and band, in accordance with an embodiment of the invention. Referring to FIG. 6A, the picture quantizer scales parameter sqmk may be stored in the quantizer storage 426 according to the table shown. The table is indexed by M rows that correspond to the band partitions and by N columns that correspond to the picture coding types. For example, for band partition 3 and picture coding type 2, the storage location in the quantizer storage 426 may be addressed by sq23.

FIG. 6B is a table that illustrates temporary quantizer storage indexing for picture coding type m, in accordance with an embodiment of the invention. Referring to FIG. 6B, the picture quantizer scales parameter qmk for picture coding type m may be stored in the temporary quantizer storage 414 according to the table shown. The table is indexed by M rows that correspond to the band partitions. For example, for band partition 2, the storage location in the temporary quantizer storage 414 may be addressed by index qm2.

FIG. 7A is a table that illustrates distortion storage indexing based on picture coding type and band, in accordance with an embodiment of the invention. Referring to FIG. 7A, the picture distortion parameter sdmk may be stored in the distortion storage 428 according to the table shown. The table is indexed by M rows that correspond to the band partitions and by N columns that correspond to the picture coding types. For example, for band partition 3 and picture coding type 2, the storage location in the distortion storage 428 may be addressed by sd23.

FIG. 7B is a table that illustrates temporary distortion storage indexing for picture coding type m, in accordance with an embodiment of the invention. Referring to FIG. 7B, the picture distortion parameter dmk for picture coding type m may be stored in the temporary distortion storage 416 according to the table shown. The table is indexed by M rows that correspond to the band partitions. For example, for band partition 2, the storage location in the temporary distortion storage 416 may be addressed by index dm2.

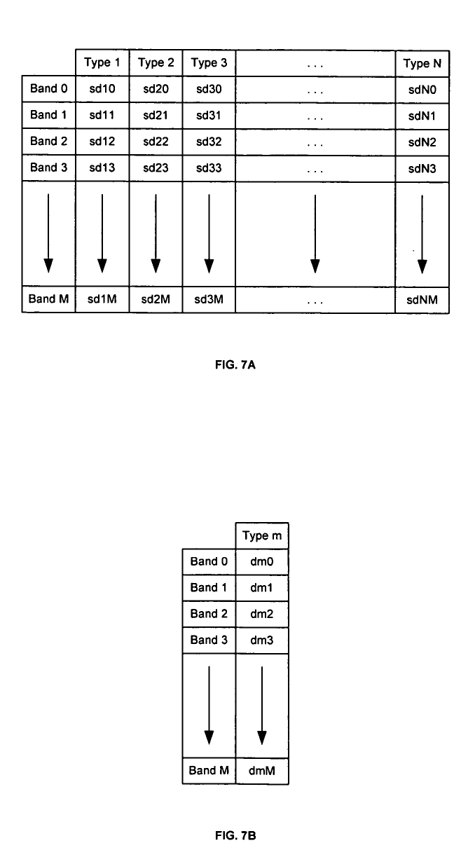

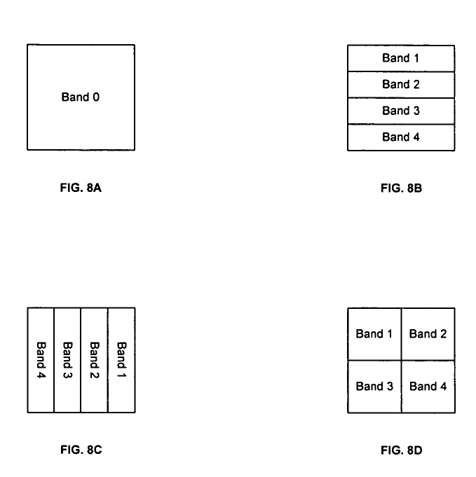

FIGS. 8A-8D illustrates exemplary band configurations, in accordance with an embodiment of the invention. Referring to FIG. 8A, a square picture may be partitioned into a single band labeled band 0. Band 0 is a special band and zero ‘0’ is not part of the typical indexing used in FIGS. 5A-7B. Band 0 may represent an average over the whole picture for any parameter, for example, dm0 and sdm0 may correspond to the averaging of parameters dmk and sdmk over the whole picture. Referring to FIG. 8B, a square picture may be partitioned into four horizontal bands of equal size. Referring to FIG. 8C, a square picture may be partitioned into four vertical bands of equal size. Referring to FIG. 8D, a square picture may be partitioned into four square bands of equal size. Band configurations are not limited to the exemplary configurations shown in FIGS. 8A-8D, for example, the original pictures need not be square pictures and the bands need not be even numbered nor of the same size.

In operation, the parametric video quality equalizer 302 may receive a signal from the picture type master 204 indicating the picture coding type n for the picture to be encoded. The FLUT 418 may utilize the picture coding type n to provide the threshold comparator 420 with the appropriate compression occurrence frequencies. The threshold comparator 420 may compare the frequency of compression occurrence fₘ of picture coding types m, where m≠n, to the threshold frequency f_{TH}. When is fₘ<f_{TH}, selective re-encoding may be chosen by the parametric video quality equalizer 302 and a signal may be sent to the picture reset 304, the pre-processor 206, and the virtual encode mode selector 306 to indicate that the selective re-encoding path has been selected. Another signal may be sent to the type and band match 422 to indicate the reset of the picture coding type to m.

When the Vmode signal from the virtual encode mode selector 306 is set to logic 1, parameters bm, qm, and dm may be sent to the statistics storage 404. The memory in the statistics storage 404 may be partitioned in accordance with the picture band configuration provided by the band configurator 402 and the parameter NbB. For example, a picture may be partitioned into k bands and each band may have NbB blocks of pixels. The statistics storage 404 may store parameters bm, qm, and dm into locations bmkl, qmkl, and dmkl, where k corresponds to the band partition and I corresponds to a block of pixels within the band partition. The total number of band partitions may be represented by M. The bmk calculator 406, the qmk calculator 408, and the dmk calculator 410 may sum and average all the locations bmkl, qmkl, and dmkl in the statistics storage 404 to determine band k parameters bmk, qmk, and dmk respectively. This calculation provides statistical conversion from block data to average band data.

Parameters bmk, qmk, and dmk may be stored in the temporary bit storage 412, the temporary quantizer storage 414, and the temporary distortion storage 416 respectively. The type and band match 422 may compare parameter bmk with all sbnk parameters stored in bit storage 424. Similarly, the type and band match 422 may compare parameters qmk and dmk to all sqmk and all sdmk parameters stored in quantizer storage 426 and distortion storage 428. Once the matching of parameters bmk, qmk, and dmk to their corresponding parameters in bit storage 424, quantizer storage 426, and distortion storage 428 is complete, the type and match band 422 may transfer the appropriate parameters to the α1 calculator 430, the α2 calculator 432, and the α3 calculator 434 to determine compression variation parameters α1, α2, and α3 respectively.

The compression variation parameter α1 may be determined by taking the sum of absolute differences between parameters dmk and sdmk over all bands and normalizing the sum over the difference for band 0. Similarly, compression variation parameter α2 may be determined by taking the sum of absolute differences between parameters qmk and sqmk over all bands and normalizing the sum over the difference for band 0 while compression variation parameter α3 may be determined by taking the sum of absolute differences between parameters dmk and sdmk over all bands and normalizing the sum over the average for band 0. Once the compression variation parameters are determined for picture coding type m, the values of α1, α2, and α3 may be compared to threshold values C*sα1, C*sα2, and C*sα3 respectively. The α1 comparator 436 may determine whether α1>C*sα1, while α2 comparator 438 and α3 comparator 440 may determine whether α2>C*sα2 and α3>C*sα3 respectively. When the compression variation parameter is larger than the threshold value, a signal may be sent to the store mode decision multiplexer 442. The store mode decision multiplexer 442 may generate the signal Smode to notify the I/O stream bus 222 in FIG. 2 whether to store the compressed picture in the bit-stream buffer 218. In one embodiment of the invention, when any of α1 comparator 436, α2 comparator 438, or α3 comparator 440 generates a signal to the store mode decision multiplexer 442, the store mode decision multiplexer 442 may set the Smode signal to a logic value of 1 to indicate that the compressed picture is to be stored in the bit-stream buffer 218. In a different embodiment of the invention, α1 comparator 436, α2 comparator 438, and α3 comparator 440 may be required to generate a signal to the store mode decision multiplexer 442 for the Smode signal to be set to a logic value of 1. The Smode signal from the store mode decision multiplexer 442 may be a weighted response from the outputs of the α1 comparator 436, the α2 comparator 438, and the α3 comparator 440.

Once the process of encoding a virtual picture of picture coding type m is completed, parameters bmk, qmk, and dmk may replace previously determined bmk, qmk, and dmk values that may currently reside in storage locations that correspond to picture coding type m and band partition k. The newly stored values of parameters bmk, qmk, and dmk may be utilized in future matching operations and future calculations of compression variation parameters.

The picture quality equalizer 208 may provide the encoder architecture 200 in FIG. 2 with the ability to selectively re-encode a “P” picture or a “B” picture into a virtual “I” picture or “VI” picture in order to enhance the statistical information that may be available for “I” pictures. Enhancing the statistical information of “I” pictures by increasing the encoding frequency allows the encoder architecture 200 to provide the additional information to the target picture bits estimation model of “I” pictures in the bit-estimator 220. Better target picture bit estimation may result in an enhanced video encoding operation for the bit-rate budget in the specified GOP structure. The encoder architecture 200 provides sufficient flexibility to implement selective re-encoding of a plurality of picture coding types into a plurality of virtual picture coding types.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video signal processing, the method comprising:
selecting at least one picture in a video sequence;
re-encoding said selected at least one picture in said video sequence;
generating statistical information from said re-encoded selected at least one picture in said video sequence; and
assigning a portion of a GOP target bit-budget according to said generated statistical information.

2. The method according to claim 1, further comprising selecting at least one picture from a specified picture coding type in said video sequence.

3. The method according to claim 2, further comprising selecting predicted pictures as said specified picture coding type.

4. The method according to claim 2, further comprising selecting bidirectional-predicted pictures as said specified picture coding type.

5. The method according to claim 1, further comprising selecting at least one picture from at least one specified picture coding type in said video sequence.

6. The method according to claim 5, further comprising selecting predictive pictures and bidirectional-predictive pictures as said specified picture coding types in said video sequence.

7. The method according to claim 1, further comprising re-encoding said selected at least one picture before encoding.

8. The method according to claim 1, further comprising re-encoding said selected at least one picture after encoding.

9. The method according to claim 1, further comprising re-encoding said selected at least one picture as a specified virtual picture coding type.

10. The method according to claim 9, further comprising selecting intra-coded pictures as said specified virtual picture coding type.

11. The method according to claim 1, further comprising scaling said selected at least one picture before said re-encoding.

12. The method according to claim 1, further comprising sub-sampling said selected at least one picture before said re-encoding.

13. The method according to claim 1, further comprising determining said at least one picture to be selected based on said generated statistical information.

14. The method according to claim 1, further comprising modifying a target picture bits estimation model based on said generated statistical information.

15. The method according to claim 14, further comprising determining said assigned portion of said GOP target bit-budget based on said modified target picture bits estimation model.

16. A system for video signal processing, the system comprising:
a picture quality equalizer that selects at least one picture in a video sequence;
at least one picture type encoding engine that re-encodes said selected at least one picture in said video sequence;
said picture quality equalizer generates statistical information from said re-encoded selected at least one picture in said video sequence; and
a bit estimator that assigns a portion of a GOP target bit-budget according to said generated statistical information.

17. The system according to claim 16, wherein said picture quality equalizer selects at least one picture from a specified picture coding type in said video sequence.

18. The system according to claim 17, wherein said picture quality equalizer selects predicted pictures as said specified picture coding type.

19. The system according to claim 17, wherein said picture quality equalizer selects bidirectional-predicted pictures as said specified picture coding type.

20. The system according to claim 16, wherein said picture quality equalizer selects at least one picture from at least one specified picture coding type in said video sequence.

21. The system according to claim 20, wherein said picture quality equalizer selects predictive pictures and bidirectional-predictive pictures as said specified picture coding types in said video sequence.

22. The system according to claim 16, wherein said at least one picture type encoding engine re-encodes said selected at least one picture before encoding.

23. The system according to claim 16, wherein said at least one picture type encoding engine re-encodes said selected at least one picture after encoding.

24. The system according to claim 16, wherein said at least one picture type encoding engine re-encodes said selected at least one picture as a specified virtual picture coding type.

25. The system according to claim 24, wherein said picture quality equalizer selects intra-coded pictures as said specified virtual picture coding type.

26. The system according to claim 16, wherein a pre-processor scales said selected at least one picture before said re-encoding.

27. The system according to claim 16, wherein a pre-processor sub-samples said selected at least one picture before said re-encoding.

28. The system according to claim 16, wherein said picture quality equalizer determines said at least one picture to be selected based on said generated statistical information.

29. The system according to claim 16, wherein said bit estimator determines said assigned portion of said GOP target bit-budget based on a target picture bits estimation model.

30. The system according to claim 16, wherein a parametric video quality equalizer configures a selective re-encoding path for re-encoding said selected at least one picture based on said generated statistical information.

31. The system according to claim 16, wherein a parametric video quality equalizer determines the at least one picture in a video sequence to select for re-encoding.
